(19) United States
(12) Patent Application Publication
(10) Pub. No.: US 2025/0326619 A1
(43) Pub. Date: Oct. 23, 2025

(54) AUTOMATED TELESCOPIC LIFT PLATFORM

(71) Applicant: ORGUEL INDUSTRIA E LOCACAO DE EQUIPAMENTOS S/A, Belo Horizonte (BR)

(72) Inventor: Sérgio FAGUNDES GUERRA LAGES, Belo Horizonte (BR)

(73) Assignee: ORGUEL INDUSTRIA E LOCACAO DE EQUIPAMENTOS S/A, Belo Horizonte, MG (BR)

(21) Appl. No.: 18/870,282

(22) PCT Filed: Oct. 24, 2023
(86) PCT No.: PCT/BR2023/050362

§ 371 Date: Nov. 27, 2024

(30) Foreign Application Priority Data
May 22, 2023 (BR) 1020230098789

(51) Int. Cl. B66F 11/04

(52) U.S. Cl. CPC B66F 11/046

(57) ABSTRACT

This utility model is applicable in the field of mechanical lifting systems. An automated telescopic lift platform, powered by an electric motor, consisting of chassis (2), telescopic columns (3.1, 3.2, 3.3), operator basket (4), support feet (5) with landing legs (5.2) and casters is presented (6). The telescopic columns (3.1, 3.2, 3.3) are composed of a fixed column (3.1) and a set of movable columns (3.2, 3.3), in which the movable columns (3.2, 3.3) are telescopically arranged and disposed surrounding the base column (3.1), the fixed column (3.1) is fixed to the chassis (2) and the movable column (3.3) is fixed to the operator basket (4). In addition, the platform has a first drive panel (7.1) installed in the operator basket (4) and a second drive panel (7.2) installed in the chassis (2), the casters (6) have a caster lock (6.1), the support feet (5) are retractable and the landing legs (5.2) of the support feet (5) are adjustable. The second drive panel (7.2) has a selector switch (9), in which, in the M0 position, the first (7.1) and second drive panels (7.2) are turned off, in the M1 position, the first drive panel (7.1) is switched on and the second drive panel (7.2) is switched off, and in the M2 position, the first drive panel (7.1) is switched off and the second drive panel (7.2) is switched on.

### CROSS-REFERENCE TO RELATED APPLICATIONS

This application is a national stage application (under 35 U.S.C. § 371) of PCT/BR2023/050362, filed Oct. 24, 2023, which claims benefit of Brazilian application Ser. No. 1020230098789, filed May 22, 2022, which are incorporated herein by reference in their entireties.

### FIELD OF APPLICATION

The present invention is applied in the field of mechanical lifting systems and refers to the automated lift platform for individual use, with a maximum height of 6 meters, which may be subject to improvement for lifting over 6 meters. Designed to be assembled and moved indoors using casters with locks.

This invention is an improvement of the utility model registered under code BR 202021003709-7, whose owner is the same.

### DESCRIPTION OF THE STATE OF THE ART

MU8701979-5 “Movable, demountable platform for lifting loads and operators for maintenance at high levels in relation to the ground” consists of equipment built in portable modules that are easy to articulate with each other, for quick assembly of the set, said modules being transportable by human force, with a base that can be moved by wheels, equipped with a lifting mechanism that can be activated manually by a crank articulated with a reducer, a pulley and a steel cable, or by any other means, such as racks and hydraulic pistons, manually or electrically operated, equipped with guardrails and an auxiliary table for carrying out the work in its upper part, as well as a warehouse of tools and parts to be used in the services, and a ladder for operator access, all within the best technical instructions and specifications for safety and health at work, to add great productivity gains to maintenance services performed at high levels in relation to the ground, due to the speed of the processes for moving auxiliary equipment, lifting loads and operators, and the reduction in the number of operators involved, generally reducing the positioning time to less of half that employed when using ladders, with a decrease in the number of operators involved, also by half, from four to two operators. The “movable, demountable platform for lifting loads and operators for maintenance at high levels in relation to the ground” is purposely built with small dimensions in terms of the area of its base and its height, when lowered, so that it can have access to various places of restricted dimensions, in terms of height and width, where, in order to compensate for the precarious balance due to the small area of its base, it has extensible and retractable auxiliary feet—called outriggers, like the devices used in crane trucks—to hold it in a secure position, both on the floor and on the side walls of the places where it is used. The “movable, demountable platform for lifting loads and operators for maintenance at high levels in relation to the ground” offers a high level of safety, having reduced the risk level of maintenance at high levels in electrical control rooms from 8 to 2 brought to zero the rate of “procedural denials” in such environments.

Document BR 202019016610-5, “Arrangement introduced in a lift platform drive assembly” refers to a drive assembly that is part of a lift platform which belongs to the technical sector of accessibility equipment in public transport vehicles, comprised by the first and second platform sections; by a pair of columns; and by the drive assembly comprised by pantographic arms for moving the second platform section with respect to the first platform section; by telescopic columns, formed by fixed external and movable internal tubular sections, in which the first section of the platform is mounted; by a pair of racks mounted on the column sections; by a pair of pinions, geared in the racks; by a shaft that has the pinions (6) mounted on it; by a pair of bearings, on which the shaft is mounted and which are mounted on the column sections; by four polymeric guide profiles, mounted inside the column section and between which the column section is guided; and a motor-reducer assembly (10).

Document BR102017003407-0, “Lift Platform With Loading/Unloading Board for People By Mechanical/Hydraulic Drive” refers to the lift platform that contains a loading/unloading board, coupled and foldable, with mechanical and hydraulic drive for use on medium and large vessels. Its movement is limited by a guide structure, where the platform moves vertically in a path, and a second unit-loading/unloading board-moves horizontally in a path, foldable in relation to the guide structure. The platform is driven by means of toothed wheels, fixed on shafts, which rotate in roller bearings, driven by roller chains, coupled to a hydraulically driven geared motor. The board is made of metal profiles with a hollow, non-slip floor and handrails with a manual mechanical lock in its structure. It is driven by a rack attached to the platform and coupled to a spur gear, attached to a geared motor with hydraulic drive. The board has a guide car on the sides, with forward and reverse displacements. At the ends of the platform, rubber stops limit the path of the board. The platform carriage and guide frame contain a two-cylinder antiwave device with compression springs forcing the platform down. For night operations, it has reflectors and signal lights. Products in this market range are mostly imported, which causes difficulties in obtaining parts, higher cost and time spent on maintenance. The typical mechanical systems of these lift platforms are driven by chains and sliding rails with a lower working height, or by means of hydraulic systems and mechanisms of the so-called “scissor” type, specific for use in higher lifting loads and working heights. The former is more primitive in terms of vertical movement dynamics than the latter. It is known that we do not have equipment to operate in the range of up to 8 meters in height in closed spaces. Most of the equipment is assembled with an electrical drive from the mechanical system.

The current state of the art has some drawbacks, the characteristics and consequences of which will be described below like other machines driven by human power.

Equipment of this type, activated by the operator, generally do not take ergonomics into account in order to reduce fatigue and muscle pain, when activated by repetitive cycles of longer duration.

The workstation in general does not have collaborative surfaces that can help in the execution of tasks, allowing the general cognitive improvement of the operator and his passive safety. Said equipment does not generally have devices that work against lateral accelerations and sudden movements, which tend to tilt the platform in such a way as to cause it to tip over.

Likewise, there is no protection system for the physical environment itself, such as unexpected collisions or scratches on walls and floors, etc. It is observed that there are difficulties in transporting this equipment, as there is no possibility of breaking it down into smaller parts, which would facilitate the reduction of the cost of carrying out the task (time) and general maintenance.

The utility model patent application BR 202021003709-7, which has the same ownership of this applicant, solves the inconveniences of the current state of the art primarily using human strength as energy for the vertical movement of the operator up to a working height of 6 meters, with a total load of 450 kg, thus eliminating inconveniences of higher operation and maintenance costs with other forms of energy.

As an improvement to the invention of BR 202021003709-7, the present application solves the problems of the state of art and presents a platform with automatic or semi-automatic activation, with an optimized platform lift system.

### SUMMARY

The present invention is presented and characterized in the independent claim, while the dependent claims describe other characteristics of the invention or modalities related to the main inventive idea.

An automated telescopic lift platform, powered by an electric motor, consisting of chassis (2), telescopic columns (3.1, 3.2, 3.3), operator basket (4), support feet (5) with landing legs (5.2) and casters is presented (6). The telescopic columns (3.1, 3.2, 3.3) are composed of a fixed column (3.1) and a set of movable columns (3.2, 3.3), in which the movable columns (3.2, 3.3) are telescopically arranged and disposed surrounding the base column (3.1), the fixed column (3.1) is fixed to the chassis (2) and the movable column (3.3) is fixed to the operator basket (4). In addition, the platform has a first drive panel (7.1) installed in the operator basket (4) and a second drive panel (7.2) installed in the chassis (2), the casters (6) have a caster lock (6.1), the support feet (5) are retractable and the landing legs (5.2) of the support feet (5) are adjustable.

The support feet (5) have a handle (5.1) configured to position and adjust the adjustable legs (5.2).

The set of movable columns (3.2, 3.3) consists of three movable columns (3.2) and a movable column (3.3) fixed to the operator basket (4). Each movable column (3.2, 3.3) is actuated by at least one threaded bar (8), preferably by exactly one threaded bar (8).

The platform reaches a maximum height of Hₘₐₓ, Hₘₐₓ preferably being 6 meters. Furthermore, the platform is stably usable at any height H in the operating range, with 0≤H≤Hₘₐₓ, where “0” corresponds to the height in non-operating mode, and “Hₘₐₓ” corresponds to the maximum height reached in operating mode.

The second drive panel (7.2) has a selector switch (9), in which, in the M0 position, the first (7.1) and second drive panels (7.2) are turned off, in the M1 position, the first drive panel (7.1) is switched on and the second drive panel (7.2) is switched off, and in the M2 position, the first drive panel (7.1) is switched off and the second drive panel (7.2) is switched on.

The platform is applicable in lifting equipment.

### Objectives

An objective of the present invention is to solve the inconveniences of the current state of the art using an automated system for raising the operator to a working height.

Another objective is to provide a platform lift that is easy to use, easy to handle, with safety locks and with low energy consumption in its use. The platform is stable, allowing safe operation during use.

### BRIEF DESCRIPTION OF THE FIGURES

These and other features of the present invention will become evident from the following description of some embodiments, given as a non-restrictive example with reference to the accompanying drawings, wherein:

FIG. 1 presents a perspective view of the lift platform in out-of-operation mode.

FIG. 2 shows a perspective view of the lift in operating mode.

FIG. 3 shows a rear perspective view of the lift platform in the off-operating mode.

FIG. 4 shows an exploded view of a movable column of the telescopic columns of the lift platform.

FIG. 5 shows a perspective view of the platform base in operating mode.

FIG. 6 shows a side view of the platform base, showing the second drive panel.

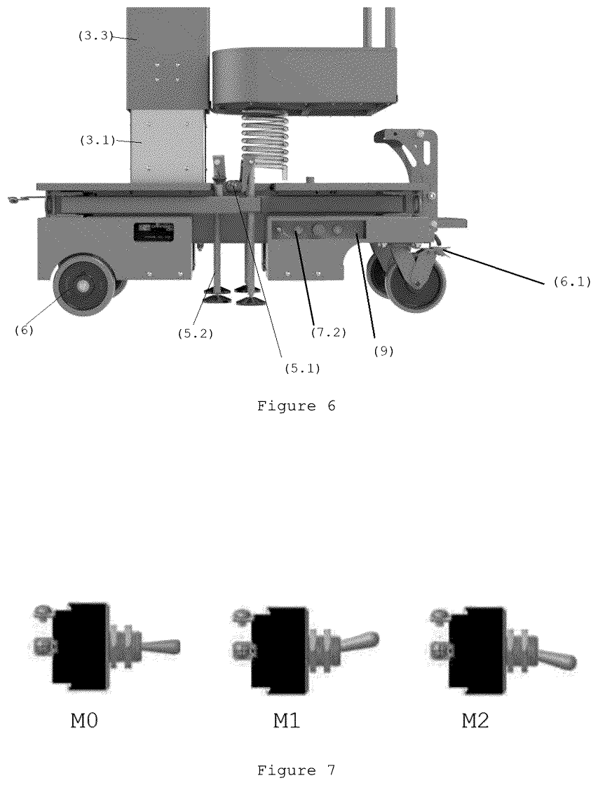

FIG. 7 shows the drive modes of the second activation panel selector switch.

FIG. 8 shows a sectional view of the telescopic columns drive mechanism.

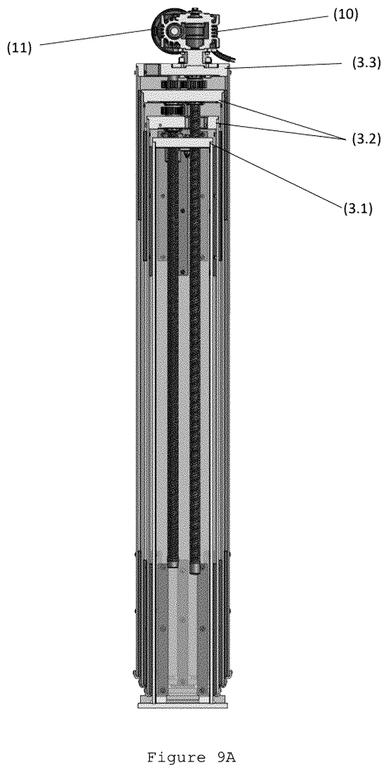

FIGS. 9A and 9B show cross-sectional views of the telescopic columns in non-operating mode.

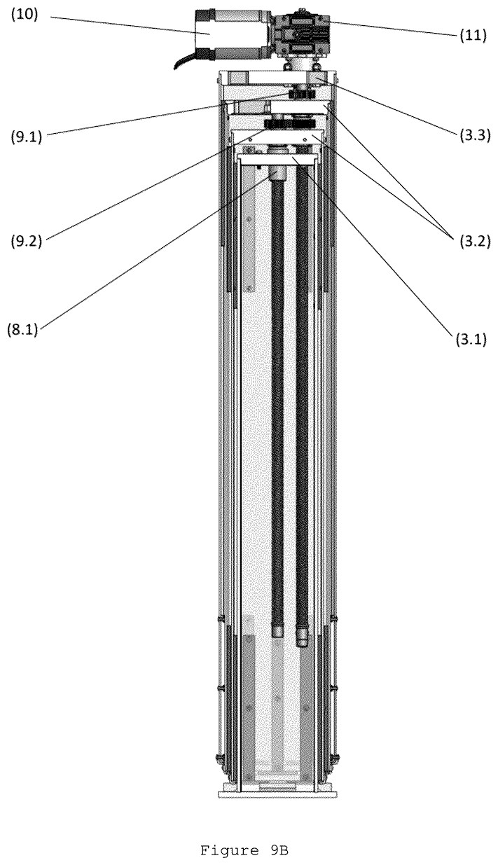

FIG. 10 shows an exploded view of the telescopic columns according to one embodiment.

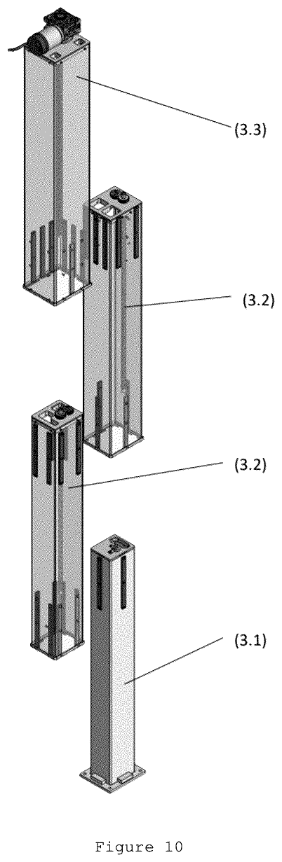

For ease of understanding, the same reference numbers have been used, where possible, to identify identical common elements in the drawings. It is understood that the elements and characteristics of a modality can be conveniently incorporated in other modalities without further clarification.

### DETAILED DESCRIPTION

Details of some embodiments of the present invention are shown in the accompanying drawings, where each example is given by way of illustration and is not to be construed as a limitation of the invention.

The platform contains a set of telescopic columns that move one at a time to perform the characteristic vertical movement, with the main objective of providing a telescopic lift system that allows the operator to carry out tasks of repair and installation of equipment, assembly/disassembly, transfer of loads or any other activity related to logistics, maintenance, and engineering at different working heights.

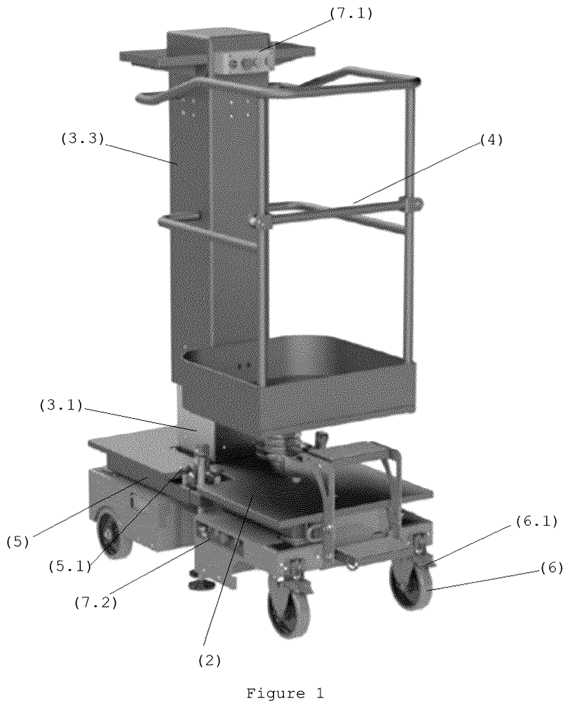

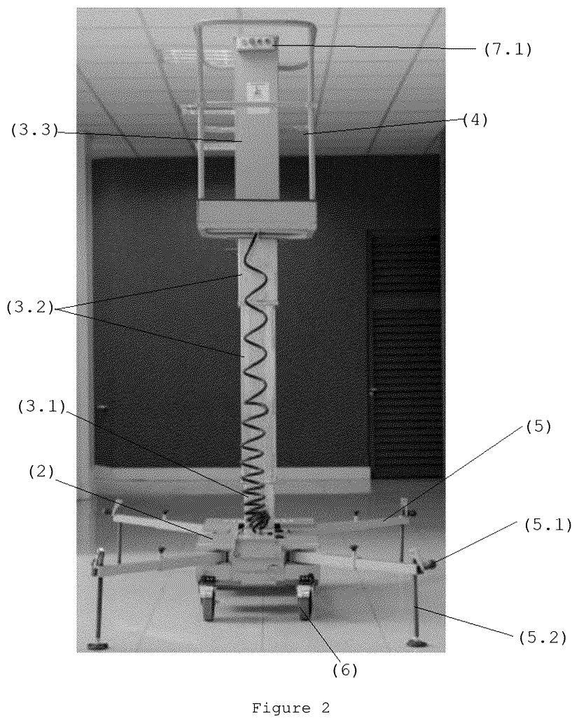

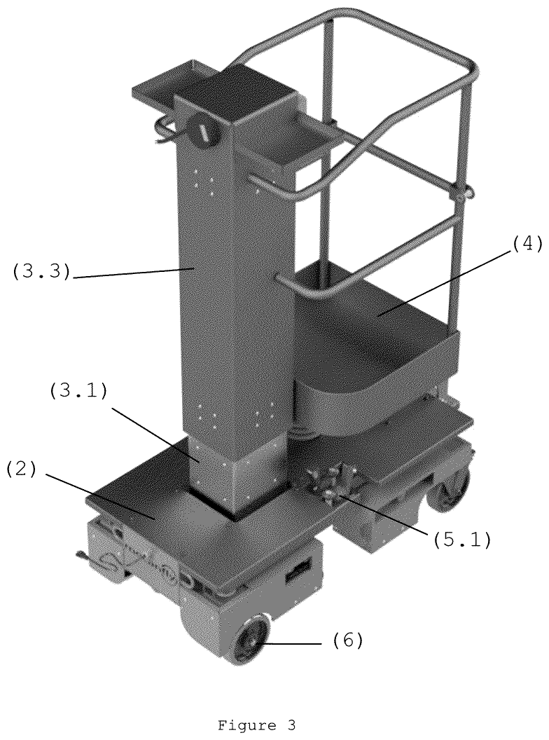

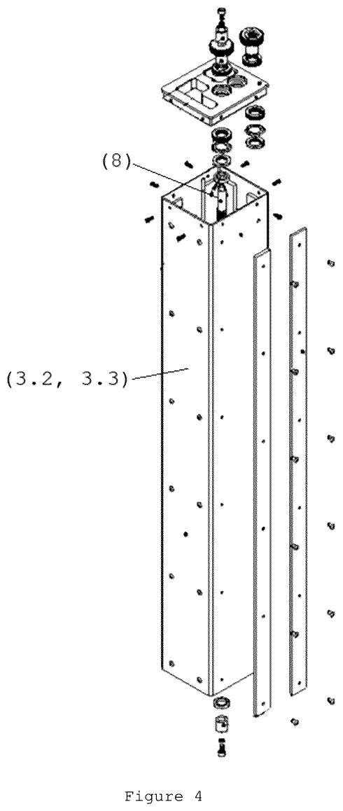

The invention, as seen in FIGS. 1 to 3, is composed of a chassis (2) with casters (6) containing caster locks (6.1). The telescopic columns (3.1, 3.2, 3.3) are composed of a fixed column (3.1), fixed to the chassis structure (2), a movable column (3.3) fixed to the operator basket (4), and a set of movable columns (3.2). The movable columns (3.2, 3.3) are connected to each other by means of at least one threaded bar (8), preferably using only one threaded bar (8), arranged eccentrically in relation to the geometric center of the cross section of the movable column (3.2, 3.3) and internally to it (FIG. 4). This movement between the columns (3.1, 3.2, 3.3) is carried out by a mechanical system composed of endless screw-type axes, assembled with gears that transmit the rotary movement along its entire length, causing the columns to move from one direction to another, successively until reaching its working height (up to 6 meters, the invention being adaptable to reach higher heights). The spindle drive system can be applied to equipment and products with the functionality of lifting parts, products, tools, equipment, or people. The “TR-25 Spindle—Trapezoidal Thread” screw system can be dimensioned according to the load and height to be lifted. Its application can be extended to equipment such as freight elevators, telescopic arms, lifting systems and others, with its original design as mentioned above remaining intact.

In the example used throughout this description, a maximum height of 6 meters is assumed. The maximum height may vary depending on how the telescopic column is made. For example, there may be variation in the design size of each of the telescopic columns (3.1 3.2, 3.3) or there may be the inclusion of additional movable columns (3.2), raising or reducing the maximum height attainable by the telescopic platform. For explanatory purposes, it is considered from this point on that the maximum height reached is 6 meters.

The elevation system allows platform stabilization at any height in the range from 0 m (height in non-operating mode) to 6 m (maximum height in operating mode). Thus, the operator can stably stop the platform at any height H, 0≤H≤6 m.

At the upper end of the last movable column (3.3) a tubular basket is fixed, corresponding to the operator basket (4). The operator basket (4) is equipped with a lockable door for operator entry and operator safety when the platform is in operation, raised to a height H.

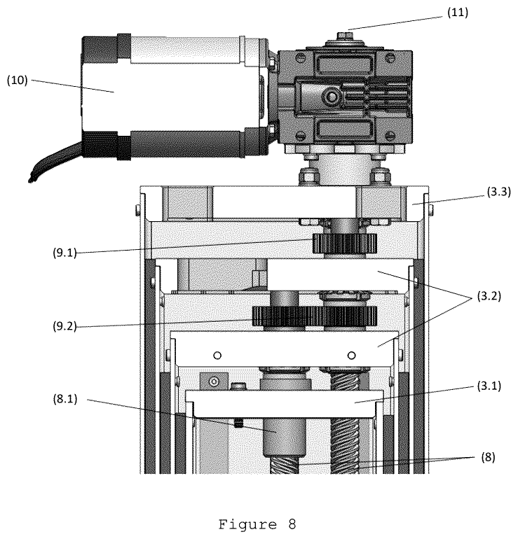

The activation of the telescopic columns is carried out by the drive panels (7.1, 7.2), the operation delimitation being given by a selector switch (9) positioned on the second drive panel (7.2). The operating positions of the selector switch are shown in FIG. 7. In the off position (M0), both the first (7.1) and second (7.2) drive panels are off. If the operator wants to lift the platform from inside the operator basket (4), the selector switch (9) must be in M1 mode. In this configuration, the first drive panel (7.1) is on, and the second drive panel (7.2) is off, and the lifting or closing of the telescopic columns (3.1, 3.2, 3.3) is performed by activating the first drive panel (7.1).

If the operator chooses to drive the platform from the second drive panel (7.2), the selector switch (9) must be in M2 mode. In this configuration, the first drive panel (7.1) is turned off and the second drive panel (7.2) is on, and the lifting or closing of the telescopic columns (3.1, 3.2, 3.3) is performed by activating the second drive panel (7.2).

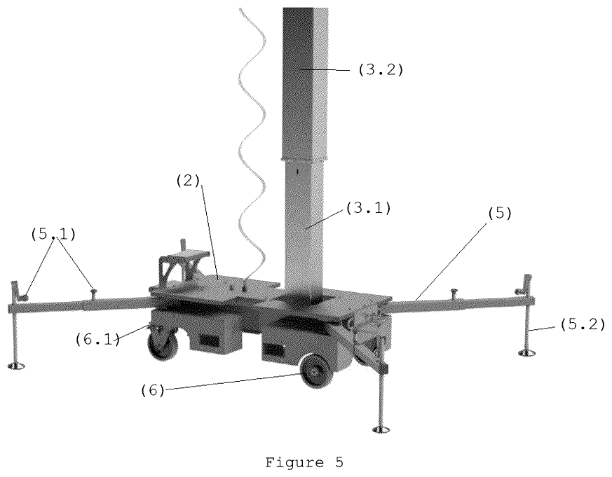

The positioning of the legs (5.2) of the support feet (5), as shown in FIG. 5, is carried out with the aid of a handle (5.1). Such handle (5.1) allows the height adjustment of the legs (5.2), ensuring platform stability in operation.

This platform has the following advantages:
allows a precise linear drive with stop at the height desired by the operator, without lurches, in an automated way,
it allows to vary the working heights at any height H in the range of 0 to 6 meters, by lifting the telescopic column,
allows to vary the maximum height reached or standard working height by varying the number of movable columns (3.2) and worm or threaded bar shafts (8) in its final assembly,
the operator basket (4) has a non-slip floor and the doors do not open outwards, increasing the operator's confidence in the equipment and in the operating safety,
the attachment of legs (5.2) on the sides in operating mode can laterally stabilize the equipment by canceling the accelerations of transverse movements, preventing the tipping movement,
the presence of a spirit level on the chassis (2) ensures the operator that the equipment is, in the working configuration, in a stable position, with angles of inclination lower than 50.

In the presented claims of this document, the references in parentheses cannot be considered as restrictive factors regarding the field of protection.

### NUMERICAL LIST OF REFERENCES

2 Chassis
3.1 Fixed telescopic column
3.2 Movable telescopic column
3.3 Movable telescopic column
4 Operator basket
5 Support foot
5.1 Handle
5.2 Adjustable leg
6 Caster
6.1 Caster lock
7.1 First drive panel
7.2 Second drive panel
8 Threaded bar (threaded spindle)
8.1 Support bushing for telescopic column drives
9.1 Primary transfer system
9.2 Lift drive transfer system
10 24V electric motor
11 Reducer

1. A mechanical system characterized by being powered by an electric motor, wherein the mechanical system comprises:
at least one threaded bar or at least one endless screw-type axis assembled with gears and connected to the electric motor, such as to transmit rotary movement along its entire length; and
the telescopic columns being composed of a fixed column and a set of movable telescopic columns, in which the movable telescopic columns are telescopically arranged and disposed surrounding the fixed telescopic column,
the movable telescopic columns being mechanically connected and actuated by the least one threaded bar or the at least one endless screw-type axis, such that the movable telescopic columns are telescopically and successively moved until they reach its working height (H), and
the mechanical system being configured to perform a telescopic movement in an automated way.

2. The mechanical system according to claim 1, characterized in that the at least one endless screw-type axis is a TR-25 Spindle—Trapezoidal Thread screw dimensioned according to load and height to be lifted.

3. The mechanical system according to claim 1, characterized in that the set of movable telescopic columns consists of three movable telescopic columns (3.2) and a movable telescopic column fixed to operator basket.

4. The mechanical system according to claim 1, characterized in that each movable telescopic column is actuated by at least one endless screw-type axis.

5. The mechanical system according to claim 1, characterized in that each movable telescopic column is actuated by exactly one threaded bar.

6. The mechanical system according to claim 1, characterized in that it is applicable in equipment such as telescopic lift platforms, freight elevators, telescopic arms, lifting systems among others.

7. The mechanical system according to claim 1, characterized by configuring a stable use in elevation at a working height H, with 0≤H≤Hₘₐₓ, in which
“0” corresponds to height in non-operating mode, and
“Hₘₐₓ” corresponds to maximum height reached in operating mode.

8. The mechanical system according to claim 7, characterized in that the maximum operating height is 6 m.

9. The mechanical system according to claim 1, characterized by comprising at least one first drive panel and a second drive panel, the second drive panel has having a selector switch, in which:
in position M0, the first and second drive panels are off,
in position M1, the first drive panel is on and the second drive panel is off, so that the lifting or closing of the telescopic columns is performed by activating the first drive panel; and
in position M2, the first drive panel is off and the second drive panel is on, so that the lifting or closing of the telescopic columns is performed by activating the second drive panel.

10. A telescopic lift platform comprising the mechanical system as defined according to claim 1, characterized by comprising a chassis and an operator basket, the fixed telescopic column is fixed to the chassis and the movable telescopic column is fixed to the operator basket, the telescopic lift platform having a first drive panel installed in the operator basket and a second drive panel installed in the chassis, the second drive panel having a selector switch, in which:
in position M0, the first and second drive panels are off,
in position M1, the first drive panel is on and the second drive panel is off, so that the lifting or closing of the telescopic columns is performed by activating the first drive panel; and
in position M2, the first drive panel is off and the second drive panel is on, so that the lifting or closing of the telescopic columns is performed by activating the second drive panel.
